(19) United States
(12) Patent Application Publication
(10) Pub. No.: US 2008/0156120 A1
(43) Pub. Date: Jul. 3, 2008

(54) Apparatus and Method for Testing Materials Exposed to Sunlight

(75) Inventor: Jorge Ricardo D'Ambrosio, Buenos Aires (AR)

Correspondence Address: NORRIS, MCLAUGHLIN & MARCUS, P.A., 875 THIRD AVE, 18TH FLOOR, NEW YORK, NY, 10022, US

(73) Assignee: Cutriembres Fonseca S.A., Buenos Aires (AR)

(21) Appl. No.: 11/958,693

(22) Filed: Dec. 18, 2007

(30) Foreign Application Priority Data
Dec. 28, 2006 (AR) P 20060105847

(51) Int. Cl. G01N 17/00

(52) U.S. Cl. 73/865.6

(57) ABSTRACT

Apparatus and method for analyzing the aging of materials exposed to sunlight, the apparatus comprising a closed cabinet that houses a light source projecting light in a light emission axis, a tray, perpendicular to the axis, carrying samples of material to be tested, and a mechanism to move the tray towards to and away from the light source.

### BACKGROUND OF THE INVENTION

1. Field of the Invention

The present invention relates to the field of testing materials to predetermine and/or estimate in advance the behavior of the materials when exposed to light, preferably sunlight, during extended periods of time, and more particularly, the invention refers to a method and apparatus for testing samples of materials to predetermine, in a fast manner, the aging that the material would undergone after a long exposure to sunlight, with the results of the inventive test being obtained in a period of time extremely shorter than the one that would take under conventional tests that are based on exposing the samples to natural sunlight for long periods of time.

For the purpose of this disclosure, the aging of the materials or matter under exposure to sunlight means the alteration of one or more characteristics of the matter or material such as resistance, color, appearance, texture, etc.

2. Description of the Prior Art

In many fields of the industry, but particularly in the industry of manufacturation of materials that are to be subjected to the sunlight for long periods of time, such as the fabrics and leathers, it is necessary to predetermine the behavior of the materials upon a severe exposition to such conditions and, among other characteristics, how the texture and pigmentation will be affected.

The test, most widely known in the art, employed by various industries, and perhaps the only one reliable, is the one know as “Arizona Test” or “Solar Test”, consisting of exposing the samples to be tested into boxes that are exposed to direct sunlight in the desert of Arizona. The boxes remain exposed to direct sunlight for periods of time from 6 to 8 months. The levels of energy reached in the Arizona Test are above the levels of other Light resistance tests, reaching the 105000 L equivalents to 4393 MJ/M2.

The sun radiation to which the samples are exposed, due to the area wherein the test (Desert of Arizona) is carried out, involves a high UV radiation. Three types of UV radiation are found in the solar radiation namely UVA, UVB and UVC. The UVB and UVC are the ones that have the longest wave lengths and are filtered by the atmosphere therefore they do not reach the soil, however, the UVA reaches the soil and, in the desert of Arizona, they reach a maximum intensity of 0.68 w/m2 during some light day hours depending of the season and weather.

In the above test, the samples are exposed to temperatures of up to 102° C. The time extension of the test is from 6 to 8 months depending on the season and weather.

These systems and processes aim to verify the resistance of several materials to the sun light on the basis of the application for which the materials have been designed, also considering different levels of light intensity and time of exposure.

As disclosed above, there is a test that is known in the art that is for testing the resistance and behavior of materials, more particularly leather employed in the seats for vehicles, which in normal use are exposed to sun light. The conditions of the test are in agreement to Rule “GMW3417 U/G-TSTL-XX Natural Weathering Exposure”. This test is carried out under exposure to sun light in the desert of Arizona and it takes between 6 to 8 months to have the test results depending on the season and weather.

In order to obtain the same or equivalent results some tests have been developed based in the concept of “emulating” y/o “reproducing” the sun light, employing Xenon lamps which better imitate the spectral curve of the sunlight, however the behavior of leather has not been correctly determined when tested by this test. These tests have not been shown that reliable results can be obtained because tested samples that resulted in positive results have then failed upon subjected to the above mentioned test carried out in the desert of Arizona.

None of the equipments for measuring resistance to Light that have been employed in the industry can provide an idea of the behavior the samples will have when exposed to the Solar Test. All of the samples that failed in the Solar Test had been previously tested in test equipments like the Solar Box or Xenon Test wherein the samples had positive test results.

Other fast aging tests have been carried out by exposing the samples to heaters for 144, 168, 240 and 360 hours at a temperature of 100° C. and 120° C.; 20 and 30 minutes to a temperature of 200° C., and any of them could not emulate or imitate the behavior of the samples when exposed to the Solar Test.

In virtue of the foregoing it would be very convenient to have a new test or method for testing materials in a manner that one could certainly foreseen the behavior of the material when exposed to the sunlight but with the test providing reliable results after a short period of time.

### SUMMARY OF THE INVENTION

It is therefore an object of the invention to provide a new apparatus to predict the behavior and/or aging of material samples which apparatus is not based in the imitation of the sunlight spectral curve but in the reproduction of the effects suffered by the materials such as leathers for vehicle tapestry that are affected by the sunlight in the GMC Test mentioned above.

It is still another object of the present invention to provide a new apparatus to predict the behavior and/or aging of material samples which apparatus reproduces and predicts how the samples will behave when subject to the above mentioned Test of General Motors in the Arizona desert, with the advantages that the results are obtained in a period of time, i.e. of about 6 to 8 days, that is notoriously shorter than the 6 to 8 months involved in the mentioned test carried out at the desert sunlight.

It is even another object of the present invention to provide a new apparatus to predict the behavior and/or aging of material samples which apparatus allows not only to testing the samples for purposes of development and further production approval but also to controlling a line production what was not feasible up to now because of the extremely long time taken by the traditional tests.

It is a further object of the present invention to provide an apparatus for testing the aging of materials under light exposure, the apparatus comprising:

a box defining a testing chamber;

a light source defining a light emission axis extending into said testing chamber;

a tray in the testing chamber for carrying at least one material sample, the tray having a sample supporting surface facing said light source and extending transversely to said light emission axis, and

a distance regulating mechanism connected to said tray to regulate the distance between said light source and the tray along said light emission axis.

It is a further object of the present invention to provide a method to determine the aging of material under light exposure, in the above mentioned apparatus, wherein the method comprises the steps of:

providing at least one first sample of the material to be tested, with the first sample having being exposed to sun light for a period of at least 8 months, which exposure produced color deviations in the first sample;

providing a second sample of the material to be tested, with the second sample being not exposed to sun light;

placing the second sample in the tray into the apparatus;

varying the distance between the tray and the light source until reaching a position at which, for a determined period of time, the same color deviations produced by the sun light in the first sample are to be generated by the light source in the second sample,

turning the light source on;

fixing radiation conditions of the light source, temperature within the testing chamber and the distance between the tray and the light source to get an aging in the second sample that is equivalent to the aging produced in the first sample by the sun light, with the aging in the second sample being obtained in a period of time shorter that said period of at least 8 months, and

determining said period of time.

### BRIEF DESCRIPTION OF THE DRAWINGS

The present invention is illustrated by way of example in the following drawings wherein:

FIG. 1 shows a perspective view of the apparatus according to a preferred embodiment of the invention;

FIG. 2 shows a perspective view, in partial cross section, of the apparatus of FIG. 1, illustrating the testing chamber thereof, and

FIG. 3 shows a perspective view of the tray for carrying samples and the distance regulating mechanism.

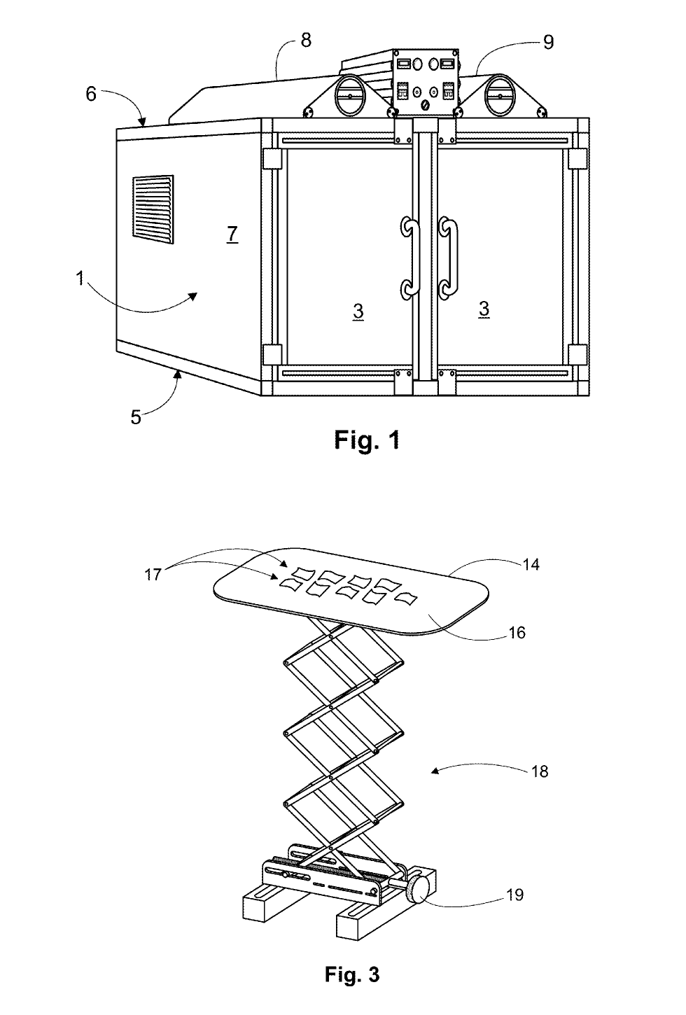

### DESCRIPTION OF THE PREFERRED EMBODIMENTS

Now referring in detail to the invention, the same refers to an apparatus to predetermine the behaviour and/or aging of several materials when exposed to the light and, more preferably, to the sunlight.

Considering the above mentioned parameters and taken into account the need of having an apparatus that would permit to shorten the periods of time involved in the known tests, the inventors worked in developing an equipment where the samples could be exposed to higher radiation levels, for 24 hours a day with the purpose of obtaining results more rapidly.

Based in the above concepts they started to work with different types of chambers, cabinets, arrangements and lamps, evaluating results in order that the effects produced in the colours would be very similar to the ones of the Solar Test but with the time involved in obtaining the results would be expectedly shorter. Finally, a chamber with trays and reflectors containing lamps were designed, with the lamp having an emission spectrum having a high content of UV radiation such as 280 to 400 nm, and also high radiation intensities in the range of 280 to 1000 nm.

The lamps were arranged within a cabinet or box with a tray for the samples capable of being varied as to the distance to the lamps for obtaining different light intensities. The equipment was also provided with other components like a timer for controlling the exposure time, an air blower or fun to keep the temperature uniform and constant into the chamber, and other supplies.

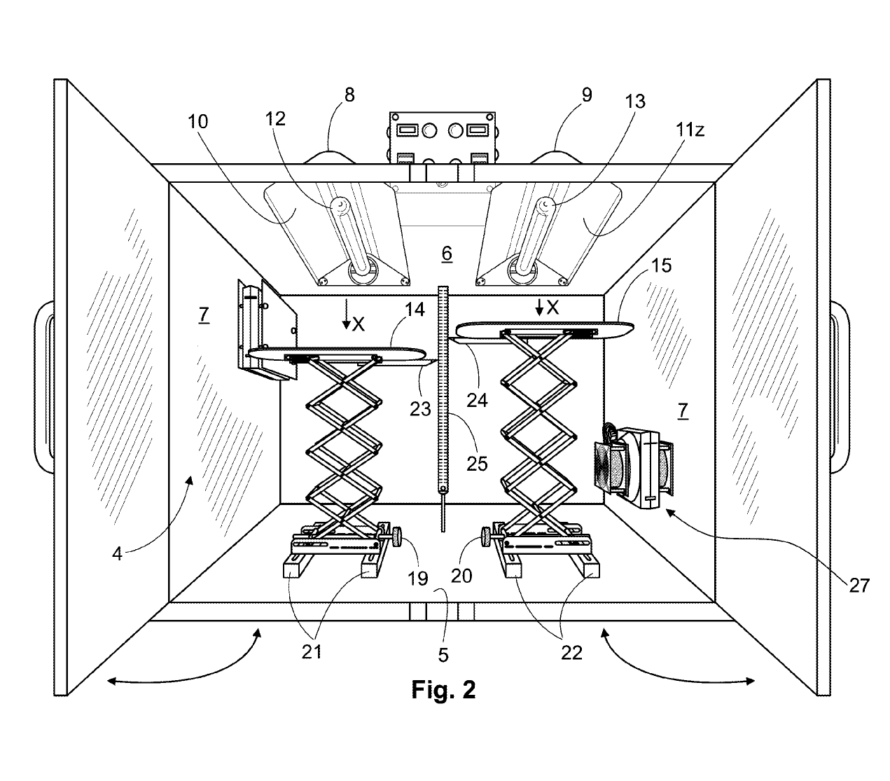

According to the invention, the apparatus as illustrated in the drawings, comprises a box o cabinet 1, preferably made of a light material such as aluminium, having a side, such as an open front side, closable by one or two doors 2, 3, in order to define a test or testing chamber 4 better illustrated in FIG. 2 that will be referred below. The box is formed preferably by a floor 5, an upper wall 6 and side walls 7, with the front part of the box being formed and closed by the above mentioned doors.

Upper wall 6 has at least one light source, preferably a couple of light sources 8, 9 which, as better seen in FIG. 2, faces the interior of chamber 4 and define a light emission axis or direction indicated by arrows X. Each light source comprises a reflector 10, 11 and a lamp 12, 13 arranged into the reflector. The reflector is preferably of the type that may be employed outdoor, with tempered translucent crystal and side walls made of aluminium, also having a reflecting screen and side diffuser. The lamp is a 1000 Watts lamp of the type of mercury gas discharge with halogenides with a UV radiation range of from about 280 to about 400 nm.

Facing each light source there is a sample-carrying tray 14, 15 which trays are clearly shown in FIGS. 2, 3. Each tray may be basically formed by an aluminium plate having an upper surface or sample supporting surface 16, see FIG. 3, for receiving the samples to be tested. The samples may comprise square pieces of the desired material, preferably pieces 17 of coloured or pigmented leather. Surface,

Supporting surface 16 directly faces its corresponding or associated light source and is arranged transversely, preferably perpendicularly, to light emission axis X as it is shown in FIG. 2. According to the teachings and concepts of the invention, tray 14 is capable of regulating its distance regarding the associated light source, or lamp, to which is facing, therefore, a distance regulating mechanism 18, as depicted in FIG. 3, is provided.

Regulating mechanism 18 comprises a scissors mechanism namely an extensible mechanism that extends and retracts along said light emission axis X by means of an actuating screw-and-knob assembly 19, 20 that may be operated within chamber 4 or may extend outside the chamber. In order to have trays 14, 15 centred in front of the corresponding light sources 8, 9, the regulating mechanism is mounted in at least one sliding track 21, 22 arranged in floor 5 of the box, to positioning the scissors mechanism into a position relative to the light source. To controllably graduate or regulate the height of tray 14, 15, the trays are provided with a pointer 23, 24 running along and in front of a rule 25 to read the distance between the tray and the light source. Rule 25 extends parallel to light emission axis X.

To keep a controlled uniform temperature within chamber 4 an air blower 26, preferably an electric fun, is provided and which is connected to an operating circuit not shown.

While the inventive apparatus has been illustrated an described as having a double testing chamber, namely two light sources, two trays, etc. it will be apparent to any expert in the art that the box may define a chamber for housing only one lamp with its sample carrying tray and all the accessories and fittings that are necessary to carry out the tests. Also, the chamber may include multiple light sources as well as the box may define a plurality of testing chambers.

In addition to the foregoing, the invention also provides a method for predicting the behavior and/or aging of material samples exposed to light, more preferably to sunlight, wherein the method comprises providing one or more samples of a matter or material to be tested, which is the first sample, with this first sample being previously exposed to sunlight by means of any of the conventional tests, such as the above mentioned Solar test, for a period of time of at least 8 months. This exposure produced color deviations in the first sample. Then, one or more samples of the same material, which are the second sample, that have not been exposed to the sunlight, are provided and introduced into the chamber and placed onto tray 14 or 15 of the inventive apparatus, and the light sources are turned-on.

With the second sample in the corresponding tray, the distance between the second sample and the associated light source is varied till finding a position of the tray in which, for a determined period of time, the color alterations or deviations generated or are to be generated in the second sample are the same to, or similar to, the ones of the first sample that have been produced by natural sunlight. The radiation conditions of the light source, the temperature within the chamber and the distance between the sample and the light source are fixed to reproduce the test with results equivalent to the aging under natural sunlight but in a shorter period of time. Finally, such shorter period of time is determined. Then, other samples of the material are subject to the same radiation conditions and at the same distance between the tray and the light source, during said period of time, to get an aging in the other sample.

Technical Specifications of the Inventive Apparatus

Box:

Integrally made of Aluminum.

Aluminum profiles, section 45×45 mm, 2R, terminated for assembling, quality (Al—Mg—Si 6060 T5, UNI 9006-1).

Weight: 1.841 Kg/m

Moment of resistance: Wx 5.50 Cm3 Wy 5.50 Cm3

Moment of inertia: 1×12.30 Cm4 Iy12.30 Cm4

Rigidity: 250 N/mm2

Tolerance according to DIN 17615

Anodized natural color and connected together by zinc-steel joints with adjustments by hidden screws.

Walls made of polished aluminum, thickness 3 mm.

Upper wall and floor made of polished aluminum, thickness 3 mm.

Doors made of aluminum profiles of 35×35 mm with 4 notches, quality (Al—Mg—Si 6060 T5, UNI 9006-1).

Weight: 1.137 Kg/m

Moment of resistance: Wx 2.69 cm3 Wy 2.69 cmm3

Moment of inertia_: Ix 4.70 cm4 Iy 4.70 cm4

Rigidity: 250 N/mm2

Tolerance according to DIN 17615

Anodized natural color and connected together by zinc-steel joints with adjustments by hidden screws.

Hinges made of aluminum and fixed with screws to the profiles and plastic handles (2) with movable fixings.

Upper wall and floor made of polished aluminum, thickness 3 mm.

Floor integrally made of natural color anodized aluminum profiles of 45×45 mm, 2R notched, quality (Al—Mg—Si 6060 T5, UNI 9006-1), joined by hidden screws and fixed to the box with the same system.

Weight: 1.844 Kg/m

Moment of resistance: Wx 7.08 Cm3 Wy 7.08 Cm3

Moment of inertia: IX 13.20 Cm4 Wy 11.40 Cm4

Rigidity: 250 N/mm2

Tolerance according to DIN 17615

Box Interior:

Distance Regulating Mechanism made of bright zinc-iron with symmetric bars hinged to provide a “scissors” effect to move up and down perpendicularly to the Light sources and reflectors. The mechanisms are manually operated through a nut-screw-knob system made of bronze (SAE 65).

Ventilation System:

Compact Electric air blower automatically controlled by a bimetallic thermostat capable of being regulated from 0° to 60°, actuated by a two-position switch with Light indicator to indicate that the blower is working.

Two ventilation grills with removable filter, preferably placed one in front to the other and at different heights.

Blower: 220 Vca.50 Hz 35VA

Flow: 130 m3/h.

Weight: 1.6 Kg reference VF 130

Ventilation grille: 250×250 mm
leveled type weight 0.46 Kg

Reference FS 130

Standard Filter reference F130

Adjustable Thermostat: from 0 to 60°c., with normally open contacts (NA), weight 40 grs

Power Imax from 2A to 250V reference TS 141

REFERENCE:
VF 130
FS 130
F 130
TS 141

Position Reading

It is directly made with the pointer (yellow color) in the trays, wherein the pointers indicate the position at the rules, with values in mm, made of stainless steel and vertically mounted from the floor to the upper wall of the cabinet.

Illumination

Reflector

The reflector is of the outdoor type, with tempered translucent crystal and side walls made of injected aluminium. With stamped reflecting screen and side diffusers made of polished aluminium plate, apt for discharge lamps with a power of 1000 W.

Weight with lamp: 1.2 kg

Symmetric projection.

Reference: 6010 C

Lamps

The lamp is a 1000 Watts lamp of the type of mercury gas discharge with halogenides, with threaded connection: E40

Luminous flux: 8000

Temperature (° K): 6000

Color reproduction index: 90

Surface termination: classic

Diameter (mm): 160

Length (mm): 340

Technical Description: SPL 1000/T/H 960/E40

Description: MBID 1000 W T/H DAYLIGHT.

Reference: sportlight 030056

Control Board

Provided with a green light signal indicating the turning-on of the equipment.

White light indicator for the operation of the lamp, controlled by a bimetallic thermostat (type CLIXON) with working range of 105° c. to 120° c. and a switch of the thermomagnetic type with capacity according to the consumption of the equipment, individual control system and turning-o system with the same characteristics.

Thermo-magnetic switch with protected pole and with a capacity of 10 A.

Reference 24401

Thermostat (type CLIXON)

Actuation Range, open 105° c. . . . closing 120° c.

I.max 2.5A. in 220V.

Reference 3BTF 120

Horimeter:

Actuating Tension: 24v to 230v.Ca.

Reset to 0 by manual knob

Reference H7 ET-NFV-B

Installation

Feed Source: 220V. Ca with Hearth connection

Initial consumption: 20 A. in operation: 12 A.

Installed Power: 4.0 kw

Dimensions:

HEIGHT: 1930 mm

WIDE: 1290 mm

DEEPNESS: 1000 mm

The invention may be better understood with reference to the following examples which are not limitative or restrictive of the scope of protection. On the contrary, it must be clearly understood that many other embodiments, modifications and alterations equivalent to the elements of the invention may be suggested by persons skilled in the art after reading the present description, without departing from the spirit of the present invention and/or the scope of the appended claims.

### EXAMPLES

Examples and Tests:

With the first uses of the inventive apparatus and tests it was some difficult to know the real working conditions because the light sources have not the same spectral curve that the one of the sunlight. Even if in two apparatuses the light sources have the same light spectral curve, the results can be different. Therefore, the inventors started working with samples that had been tested in the Solar Test in order to quantify the changes or alterations in the samples and thus having reference samples. The sample of WO 4505T was employed, which sample had been tested in the Solar test and had failed at the 6000 L. Readings of the samples were made at 20, 40 and 6000 L.

The test consisted in placing the sample in inventive apparatus under different conditions, varying the distance between the sample and the light sources till finding a position at which, in a predetermined time, the color deviations or alterations or changes observed in the sample were similar to those produced in the Solar Test.

With the working conditions determined by an spectrometer and 4-channel optometer, the spectral curve and the radiation intensity were measured from the 280 nm to 1000 nm, in a manner to fix the parameters of the equipment to work with always under the same conditions of radiation, temperature and distance between the samples and the light source. In addition, the equipment allowed to test new lamps and to determine that all of them are similar or identical and also to control the aging of the same during use thereof. This permitted to have an apparatus wherein the working conditions are perfectly repeated and kept constant for all the tests.

Once the conditions have been defined, the WO 4505T was checked again, together with samples IDN 04204, originally approved by color Nuance 830K LG and rejected in the Test and a sample of 830K LG produced in EONA, which was approved in the Solar Test.

Sample 1: Nuance 830 LG WO 4505T, failed in the Solar Test at 60000 L

Sample 2: Nuance 830 K originally approved by color IDN 04204, but also failed.

Sample 3: Nuance 830 K LG produced in EONA.

The obtained results are shown in the following Table:

NOTE: The apparatus of the present invention, for the purpose of the present disclosure, will be referred as the FSTS.

FSTS NUANCE 830K IDN 04204

| | DL | Da | Db | C | DE | Grey Scale |
|---|---|---|---|---|---|---|
| 20K | | | | 0.00 | | |
| 40K | | | | 0.00 | | |
| 60K | | | | 0.00 | | |
| 24 | −0.24 | −0.33 | 0.25 | 0.41 | 0.48 | 4/5 |
| 48 | −0.13 | −0.34 | 0.51 | 0.61 | 0.63 | 4/5 |
| 72 | 0.37 | −0.65 | 0.51 | 0.83 | 0.91 | 4/5 |
| 96 | 0.45 | −0.81 | 0.63 | 1.03 | 1.12 | 4/5 |
| 120 | 0.56 | −0.88 | 0.71 | 1.13 | 1.26 | 4/5 |
| 144 | 0.65 | −0.97 | 0.73 | 1.21 | 1.38 | 4 |
| 168 | 0.72 | −1.22 | 0.94 | 1.54 | 1.70 | 4 |
| 192 | 0.72 | −1.38 | 1.04 | 1.73 | 1.87 | 4 |
| 216 | 0.73 | −1.51 | 1.15 | 1.90 | 2.03 | 4 |
| 240 | 0.86 | −1.93 | 1.25 | 2.30 | 2.45 | 3/4 |
| 264 | 0.91 | −2.05 | 1.30 | 2.43 | 2.59 | 3/4 |
| 288 | 0.93 | −2.21 | 1.41 | 2.62 | 2.79 | 3/4 |
| 312 | 1.14 | −2.44 | 1.56 | 2.90 | 3.11 | 3 |
| 336 | 1.25 | −2.69 | 1.76 | 3.21 | 3.45 | 3 |
| 360 | 1.34 | −3.14 | 2.26 | 3.87 | 4.09 | 3 |

FSTS NUANCE 830K WO 4505 T

| | DL | Da | Db | C | DE | Grey Scale |
|---|---|---|---|---|---|---|
| 20K | 0.14 | −0.20 | 0.13 | 0.24 | 0.28 | |
| 40K | 0.34 | −0.46 | 0.37 | 0.59 | 0.68 | |
| 60K | 0.52 | −0.72 | 0.59 | 0.93 | 1.07 | |
| 24 | −0.14 | −0.38 | 0.49 | 0.62 | 0.64 | 4/5 |
| 48 | 0.01 | −0.82 | 0.63 | 1.03 | 1.03 | 4/5 |
| 72 | 0.50 | −0.94 | 0.61 | 1.12 | 1.12 | 4/5 |
| 96 | 0.57 | −1.22 | 0.89 | 1.51 | 1.51 | 4 |
| 120 | 0.90 | −1.80 | 1.13 | 2.13 | 2.31 | 3/4 |
| 144 | 1.11 | −2.07 | 1.28 | 2.43 | 2.67 | 3/4 |
| 168 | 1.11 | −2.29 | 1.57 | 2.78 | 2.99 | 3/4 |
| 192 | 1.17 | −2.59 | 1.89 | 3.21 | 3.41 | 3 |
| 216 | 1.25 | −2.60 | 1.77 | 3.15 | 3.38 | 3 |
| 240 | 1.35 | −2.51 | 1.51 | 2.93 | 3.23 | 3 |
| 264 | 1.49 | −2.97 | 1.80 | 3.47 | 3.77 | 3 |
| 288 | 1.65 | −3.13 | 1.90 | 3.66 | 4.02 | 3 |
| 312 | 1.83 | −3.38 | 2.10 | 3.98 | 4.38 | 2/3 |
| 336 | 1.89 | −3.82 | 2.28 | 4.45 | 4.65 | 2/3 |
| 360 | 2.04 | −4.04 | 2.65 | 4.83 | 5.24 | 2/3 |

FSTS NUANCE 830K LG EONA

| Time | DL | Da | Db | C | DE | Grey Scale |
|---|---|---|---|---|---|---|
| 24 | −0.55 | 0.05 | 0.25 | 0.25 | 0.61 | 4/5 |
| 48 | −0.63 | 0.05 | 0.19 | 0.20 | 0.66 | 4/5 |
| 72 | −0.75 | 0.05 | 0.13 | 0.14 | 0.76 | 4/5 |
| 96 | −0.84 | 0.06 | 0.06 | 0.08 | 0.84 | 4/5 |
| 120 | −0.94 | 0.08 | 0.08 | 0.11 | 0.95 | 4/5 |
| 144 | −1.01 | 0.09 | 0.06 | 0.11 | 1.02 | 4/5 |
| 168 | −1.04 | 0.07 | −0.01 | 0.07 | 1.04 | 4/5 |
| 192 | −1.17 | 0.08 | 0.04 | 0.09 | 1.17 | 4/5 |
| 216 | −1.27 | 0.05 | −0.01 | 0.05 | 1.27 | 4 |
| 240 | −1.33 | 0.07 | 0.02 | 0.07 | 1.33 | 4 |
| 264 | −1.4 | 0.08 | 0.05 | 0.09 | 1.40 | 4 |
| 288 | −1.5 | 0.08 | 0.05 | 0.09 | 1.50 | 4 |
| 312 | −1.62 | 0.09 | 0.05 | 0.10 | 1.62 | 4 |
| 336 | −1.68 | 0.1 | −0.02 | 0.10 | 1.68 | 4 |
| 360 | −1.89 | 0.08 | −0.05 | 0.09 | 1.89 | 4 |

From the obtained results the following conclusions may be stated:

1—The working conditions in the FSTS permit to get large color changes due to exposure to the Light in a very fast way, 10 to 15 days, and said changes or alterations in the samples are very similar to those obtained by the Solar Test.

2—While the conditions are very aggressive some samples keep practically unaltered (Nuance 830K EONA), in the same period of time that other samples are entirely decayed (WO 45058, IDN 04204).

3—The working conditions in the FSTS are completely controllable and repeatable.

1-d. Correlations between FSTS and Solar Test.

In order to get more information and verify the similarities between the inventive equipment and the Solar Test, different samples from the laboratory of EOGH were received, with the samples having different colors and that were controlled under the Solar Test with different results. Samples subject to exposures of up to 105000 Langleys (L), as well as to 2000, 4000 and 6000 (L), were also received, which samples were compared by computer with the results obtained in the inventive apparatus.

All the samples were placed for 360 hours under the same predetermined conditions and were checked each 24 hours.

The results are shown in all the following Tables.

830K NAE 4859 04/06/04

| | | | | | |
|---|---|---|---|---|---|
| DL | Da | Db | C | DE | Grey Scale |

SOLAR TEST

| | | | | | |
|---|---|---|---|---|---|
| L | | | | | |
| 20K | 0.89 | −1.01 | −0.59 | 1.17 | 1.47 |
| 40K | 0.51 | −1.71 | −1.4 | 2.21 | 2.23 |
| 60K | 2.3 | −2.91 | −1.75 | 3.40 | 4.62 |
| 105K | 2.69 | −3.49 | −4.84 | 5.97 | 6.55 |

FSTS

| | | | | | | |
|---|---|---|---|---|---|---|
| T | | | | | | |
| 24 | 0.34 | −0.55 | 0.15 | 0.57 | 0.66 | 4 |
| 48 | 0.74 | −1.07 | −0.26 | 1.10 | 1.33 | 4 |
| 72 | 2.06 | −1.72 | −0.67 | 1.85 | 2.06 | 4 |
| 96 | 1.41 | −2.2 | −1.07 | 2.45 | 2.82 | 3/4 |
| 120 | 1.58 | −2.44 | −1.44 | 2.83 | 3.25 | 3 |
| 144 | 1.8 | −2.67 | −1.94 | 3.30 | 3.76 | 3 |
| 168 | 1.84 | −2.76 | −2.45 | 3.69 | 4.12 | 3 |
| 192 | 2.01 | −2.9 | −3.29 | 4.39 | 4.82 | 3 |
| 216 | 2.14 | −3.17 | −4.35 | 5.38 | 5.79 | 2/3 |
| 240 | 2.26 | −3.39 | −4.79 | 5.87 | 6.29 | 2 |
| 264 | 2.38 | −3.27 | −5.64 | 6.52 | 6.94 | 2 |
| 288 | 2.29 | −3.18 | −6.01 | 6.80 | 7.17 | 2 |
| 312 | 2.15 | −3.06 | −5.86 | 6.61 | 6.95 | 2 |
| 336 | 2.06 | −3.02 | −6.31 | 7.00 | 7.29 | 2 |
| 360 | 2.23 | −3.16 | −6.91 | 7.60 | 7.92 | 2 |

830K NAE 5528 04/11/04

| | | | | | |
|---|---|---|---|---|---|
| DL | Da | Db | C | DE | Grey Scale |

SOLAR TEST

| | | | | | |
|---|---|---|---|---|---|
| L | | | | | |
| 20000 L | 0.39 | −0.70 | 0.77 | 1.04 | 1.11 |

FSTS

| | | | | | | |
|---|---|---|---|---|---|---|
| T (hs) | | | | | | |
| 24 | 0.15 | −0.30 | 0.53 | 0.61 | 0.63 | 4/5 |
| 48 | 0.34 | −0.88 | 0.89 | 1.25 | 1.30 | 4 |
| 72 | 0.47 | −1.24 | 1.15 | 1.69 | 1.75 | 4 |
| 96 | 0.92 | −1.81 | 1.45 | 2.32 | 2.43 | 3/4 |
| 120 | 0.96 | −2.18 | 1.61 | 2.71 | 2.88 | 3/4 |
| 144 | 0.95 | −2.38 | 1.72 | 2.94 | 3.08 | 3 |
| 168 | 0.88 | −2.69 | 1.99 | 3.35 | 3.46 | 3 |
| 192 | 0.89 | −2.85 | 2.17 | 3.58 | 3.69 | 3 |
| 216 | 0.86 | −3.00 | 2.32 | 3.79 | 3.89 | 3 |
| 240 | 0.91 | −3.06 | 2.39 | 3.88 | 3.99 | 3 |
| 264 | 0.83 | −3.08 | 2.40 | 3.90 | 3.99 | 3 |
| 288 | 0.90 | −3.14 | 2.38 | 3.94 | 4.04 | 3 |
| 312 | 0.73 | −3.07 | 2.56 | 4.00 | 4.06 | 3 |
| 336 | 0.70 | −3.05 | 2.52 | 3.96 | 4.02 | 3 |
| 360 | 0.66 | −3.06 | 2.47 | 3.93 | 3.99 | 3 |

9772 NAE 5167 29/07/04

| | | | | | |
|---|---|---|---|---|---|
| DL | Da | Db | C | DE | Grey Scale |

SOLAR TEST

| | | | | | |
|---|---|---|---|---|---|
| L | | | | | |
| 20000 | 0.96 | −1.44 | 1.26 | 1.91 | 2.14 |
| 40000 | 1.77 | −2.42 | 1.38 | 2.79 | 3.3 |
| 60000 | 2.05 | −2.88 | 1.18 | 3.11 | 3.73 |

FSTS

| | | | | | | |
|---|---|---|---|---|---|---|
| T (HS) | | | | | | |
| 24 | 0.62 | −0.55 | 0.73 | 0.91 | 1.10 | 4/5 |
| 48 | 1.03 | −1.45 | 1.52 | 2.10 | 2.34 | 3/4 |
| 72 | 1.15 | −1.88 | 1.85 | 2.64 | 2.87 | 3/4 |
| 96 | 1.48 | −2.27 | 1.59 | 2.77 | 3.14 | 3 |
| 120 | 1.5 | −2.56 | 1.86 | 3.16 | 3.5 | 3 |
| 144 | 1.66 | −2.65 | 1.9 | 3.26 | 3.66 | 3 |
| 168 | 1.59 | −2.71 | 1.92 | 3.32 | 3.68 | 3 |
| 192 | 1.65 | −2.8 | 1.85 | 3.36 | 3.74 | 3 |
| 216 | 1.8 | −2.93 | 1.7 | 3.39 | 3.84 | 3 |
| 240 | 1.6 | −2.82 | 1.73 | 3.31 | 3.67 | 3 |
| 264 | 1.66 | −2.86 | 1.63 | 3.29 | 3.69 | 3 |
| 288 | 1.49 | −2.79 | 1.73 | 3.28 | 3.61 | 3 |
| 312 | 1.42 | −2.82 | 1.73 | 3.31 | 3.60 | 3 |
| 336 | 1.43 | −2.9 | 1.7 | 3.36 | 3.65 | 3 |
| 360 | 1.45 | −2.98 | 1.68 | 3.42 | 3.72 | 3 |

830 K NAE 5168 29/07/04

| | | | | | |
|---|---|---|---|---|---|
| DL | Da | Db | C | DE | Grey Scale |

SOLAR TEST

| | | | | | |
|---|---|---|---|---|---|
| L | | | | | |
| 20000 | 0.71 | −0.99 | 0.25 | 1.02 | 1.25 |
| 40000 | 1.36 | −1.65 | −0.68 | 1.78 | 2.24 |
| 60000 | 1.73 | −1.98 | −1.37 | 2.41 | 2.97 |

FSTS

| | | | | | | |
|---|---|---|---|---|---|---|
| T (HS) | | | | | | |
| 24 | 0.75 | −1.05 | 0.65 | 1.23 | 1.44 | 4 |
| 48 | 1.52 | −2.48 | 0.53 | 2.54 | 2.96 | 4 |
| 72 | 1.7 | −2.73 | 0.3 | 2.75 | 3.23 | 3 |
| 96 | 1.74 | −2.83 | 0.05 | 2.83 | 3.32 | 3 |
| 120 | 2 | −3.29 | −0.2 | 3.30 | 3.85 | 3 |
| 144 | 2.22 | −3.52 | −0.54 | 3.56 | 4.19 | 2/3 |
| 168 | 2.29 | −3.71 | −1.03 | 3.85 | 4.48 | 2/3 |
| 192 | 2.35 | −3.75 | −1.49 | 4.04 | 4.67 | 2/3 |
| 216 | 2.41 | −3.83 | −1.75 | 4.21 | 4.85 | 2/3 |
| 240 | 2.46 | −3.95 | −1.98 | 4.42 | 5.06 | 2/3 |
| 264 | 2.54 | −3.99 | −2.41 | 4.66 | 5.31 | 2/3 |
| 288 | 2.51 | −4.05 | −2.65 | 4.84 | 5.45 | 2/3 |
| 312 | 2.57 | −4.11 | −2.84 | 5.00 | 5.62 | 2/3 |
| 336 | 2.28 | −4.08 | −3.17 | 5.17 | 5.65 | 2/3 |
| 360 | 2.35 | −4.15 | −3.35 | 5.33 | 5.83 | 2/3 |

149 B N^{o}5

| | | | | | |
|---|---|---|---|---|---|
| DL | Da | Db | C | DE | Grey Scale |

SOLAR TEST

| | | | | | |
|---|---|---|---|---|---|
| L | | | | | |
| 20000 | 1.19 | −1.05 | 1.08 | 1.51 | 1.92 |
| 40000 | 1.82 | −1.56 | 1.76 | 2.35 | 2.97 |

FSTS

| | | | | | | |
|---|---|---|---|---|---|---|
| T (HS) | | | | | | |
| 24 | 0.77 | −0.65 | 0.95 | 1.15 | 1.38 | 4 |
| 48 | 1.47 | −1.59 | 2.02 | 2.57 | 2.96 | 3/4 |
| 72 | 1.37 | −1.73 | 2.26 | 2.85 | 3.16 | 3/4 |
| 96 | 1.48 | −1.72 | 2.13 | 2.74 | 3.11 | 3 |
| 120 | 1.52 | −1.77 | 2.23 | 2.85 | 3.23 | 3 |
| 144 | 1.36 | −1.78 | 2.62 | 3.17 | 3.45 | 3 |
| 168 | 1.42 | −1.81 | 2.54 | 3.12 | 3.43 | 3 |
| 192 | 1.4 | −1.79 | 2.55 | 3.12 | 3.42 | 3 |
| 216 | 1.44 | −1.8 | 2.56 | 3.13 | 3.44 | 3 |
| 240 | 1.32 | −1.78 | 2.76 | 3.28 | 3.54 | 3 |
| 264 | 1.27 | −1.73 | 2.88 | 3.36 | 3.59 | 3 |
| 288 | 1.26 | −1.75 | 2.73 | 3.24 | 3.48 | 3 |
| 312 | 1.04 | −1.76 | 2.89 | 3.38 | 3.54 | 3 |
| 336 | 0.72 | −1.7 | 3.12 | 3.55 | 3.63 | 3 |
| 360 | 0.81 | −1.75 | 3.2 | 3.65 | 3.74 | 3 |

830K N^{o}6

| | | | | | |
|---|---|---|---|---|---|
| DL | Da | Db | C | DE | Grey Scale |

SOLAR TEST

| | | | | | |
|---|---|---|---|---|---|
| L | | | | | |
| 20000 | 0.68 | −0.99 | 0.22 | 1.01 | 1.22 |

FSTS

| | | | | | | |
|---|---|---|---|---|---|---|
| T (HS) | | | | | | |
| 24 | 0.45 | −0.35 | 0.45 | 0.57 | 0.73 | 4/5 |
| 48 | 0.65 | −0.93 | 0.70 | 1.16 | 1.33 | 4/5 |
| 72 | 1.07 | −1.89 | 0.52 | 1.96 | 2.23 | 3/4 |
| 96 | 1.39 | −2.48 | 0.55 | 2.54 | 2.90 | 3/4 |
| 120 | 1.37 | −2.49 | 0.21 | 2.50 | 2.85 | 3/4 |
| 144 | 1.58 | −2.78 | −0.07 | 2.78 | 3.20 | 3 |
| 168 | 1.78 | −3.37 | −0.35 | 3.39 | 3.83 | 3 |
| 192 | 2.19 | −3.50 | −1.05 | 3.65 | 4.26 | 2/3 |
| 216 | 2.59 | −4.03 | −1.60 | 4.34 | 5.05 | 2/3 |
| 240 | 2.31 | −3.98 | −1.95 | 4.43 | 5.00 | 2/3 |
| 264 | 2.64 | −4.09 | −2.47 | 4.78 | 5.46 | 2/3 |
| 288 | 2.65 | −4.15 | −2.80 | 5.01 | 5.66 | 2/3 |
| 312 | 2.78 | −4.13 | −3.01 | 5.11 | 5.82 | 2/3 |
| 336 | 2.66 | −4.17 | −3.23 | 5.27 | 5.91 | 2/3 |
| 360 | 2.71 | −4.21 | −3.45 | 5.44 | 6.08 | 2/3 |

NUANCE 9772 N^{o}7

| | | | | | |
|---|---|---|---|---|---|
| DL | Da | Db | C | DE | Grey Scale |

SOLAR TEST

| L | | | | | |
|---|---|---|---|---|---|
| 20000 | 1.17 | −1.57 | 1.19 | 1.97 | 2.29 |

FSTS

| | | | | | | |
|---|---|---|---|---|---|---|
| 24 | 0.72 | −0.55 | 0.72 | 0.91 | 1.16 | 4 |
| 48 | 1.42 | −1.94 | 1.59 | 2.51 | 2.88 | 3/4 |
| 72 | 1.36 | −2.08 | 1.77 | 2.73 | 3.05 | 3 |
| 96 | 1.77 | −2.35 | 1.71 | 2.91 | 3.40 | 3 |
| 120 | 1.61 | −2.54 | 1.83 | 3.13 | 3.52 | 3 |
| 144 | 1.55 | −2.56 | 1.98 | 3.24 | 3.59 | 3 |
| 168 | 1.43 | −2.64 | 1.84 | 3.22 | 3.52 | 3 |
| 192 | 1.45 | −2.63 | 1.86 | 3.22 | 3.53 | 3 |
| 216 | 1.42 | −2.67 | 1.86 | 3.25 | 3.55 | 3 |
| 240 | 1.36 | −2.75 | 1.69 | 3.23 | 3.50 | 3 |
| 264 | 1.47 | −2.75 | 1.70 | 3.23 | 3.55 | 3 |
| 288 | 1.46 | −2.78 | 1.68 | 3.25 | 3.56 | 3 |
| 312 | 1.26 | −2.60 | 1.83 | 3.18 | 3.42 | 3 |
| 336 | 0.75 | −2.55 | 2.09 | 3.30 | 3.38 | 3 |
| 360 | 0.79 | −2.59 | 2.21 | 3.40 | 3.50 | 3 |

NUANCE 830K WO 4505 T

| | | | | | |
|---|---|---|---|---|---|
| DL | Da | Db | C | DE | Grey Scale |

SOLAR TEST

| | | | | | |
|---|---|---|---|---|---|
| L | | | | | |
| 20000 | 0.14 | −0.20 | 0.13 | 0.24 | 0.28 |
| 40000 | 0.34 | −0.46 | 0.37 | 0.59 | 0.68 |
| 60000 | 0.52 | −0.72 | 0.59 | 0.93 | 1.07 |

FSTS

| | | | | | | |
|---|---|---|---|---|---|---|
| T (HS) | | | | | | |
| 24 | −0.14 | −0.38 | 0.49 | 0.62 | 0.64 | 4/5 |
| 48 | 0.01 | −0.82 | 0.63 | 1.03 | 1.03 | 4/5 |
| 72 | 0.50 | −0.94 | 0.61 | 1.12 | 1.12 | 4/5 |
| 96 | 0.57 | −1.22 | 0.89 | 1.51 | 1.51 | 4 |
| 120 | 0.90 | −1.80 | 1.13 | 2.13 | 2.31 | 3/4 |
| 144 | 1.11 | −2.07 | 1.28 | 2.43 | 2.67 | 3/4 |
| 168 | 1.11 | −2.29 | 1.57 | 2.78 | 2.99 | 3/4 |
| 192 | 1.17 | −2.59 | 1.89 | 3.21 | 3.41 | 3 |
| 216 | 1.25 | −2.60 | 1.77 | 3.15 | 3.38 | 3 |
| 240 | 1.35 | −2.51 | 1.51 | 2.93 | 3.23 | 3 |
| 264 | 1.49 | −2.97 | 1.80 | 3.47 | 3.77 | 3 |
| 288 | 1.65 | −3.13 | 1.90 | 3.66 | 4.02 | 3 |
| 312 | 1.83 | −3.38 | 2.10 | 3.98 | 4.38 | 2/3 |
| 336 | 1.89 | −3.82 | 2.28 | 4.45 | 4.65 | 2/3 |
| 360 | 2.04 | −4.04 | 2.65 | 4.83 | 5.24 | 2/3 |

FSTS
Meridian 830 Var 3 originally approved by color,
Rejected in the Solar Test

| T (HS) | DL | Da | Db | C | DE | Grey Scale |
|---|---|---|---|---|---|---|
| 24 | 0.15 | −0.18 | 0.57 | 0.60 | 0.62 | 4/5 |
| 48 | 0.25 | −0.53 | 0.68 | 0.86 | 0.90 | 4/5 |
| 72 | 0.39 | −0.84 | 1.12 | 1.40 | 1.45 | 4 |
| 96 | 0.49 | −1.32 | 1.37 | 1.90 | 1.96 | 4 |
| 120 | 0.58 | −1.44 | 1.41 | 2.02 | 2.10 | 4 |
| 144 | 0.64 | −1.73 | 1.61 | 2.36 | 2.45 | 3/4 |
| 168 | 0.90 | −2.13 | 1.86 | 2.83 | 2.97 | 3/4 |
| 192 | 0.87 | −2.47 | 2.08 | 3.23 | 3.34 | 3 |
| 216 | 0.96 | −2.74 | 2.24 | 3.54 | 3.67 | 3 |
| 240 | 1.02 | −2.95 | 2.36 | 3.78 | 3.91 | 3 |
| 264 | 1.15 | −3.29 | 2.56 | 4.17 | 4.32 | 2/3 |
| 288 | 1.23 | −3.41 | 2.62 | 4.30 | 4.47 | 2/3 |
| 312 | 1.42 | −3.55 | 2.75 | 4.49 | 4.71 | 2/3 |
| 336 | 1.42 | −3.88 | 3.00 | 4.90 | 5.11 | 2/3 |
| 360 | 1.42 | −4.06 | 3.23 | 5.19 | 5.38 | 2/3 |

Nuance 521Q EQ LAB 401346

| | | | | | |
|---|---|---|---|---|---|
| DL | DA | DB | C | DE | G. Sc. |

SOLAR TEST

| | | | | | |
|---|---|---|---|---|---|
| Langley | | | | | |
| | 0 | 0 | 0 | 0 | 0 |
| 20000 | −0.18 | 0.12 | −0.53 | 0.54 | 0.57 |
| 40000 | −0.47 | 0.14 | −1.23 | 1.24 | 1.32 |
| 60000 | −0.30 | 0.31 | −1.49 | 1.52 | 1.55 |

FST

| | | | | | | |
|---|---|---|---|---|---|---|
| Time (hs) | | | | | | |
| 0 | 0.00 | 0.00 | 0.00 | 0.00 | 0.00 | |
| 24 | −0.60 | 0.14 | 0.19 | 0.24 | 0.64 | 4/5 |
| 48 | −0.79 | 0.20 | −0.02 | 0.20 | 0.82 | 4/5 |
| 72 | −0.98 | 0.25 | −0.37 | 0.45 | 1.08 | 4/5 |
| 96 | −0.96 | 0.30 | −0.75 | 0.81 | 1.25 | 4/5 |
| 120 | −1.01 | 0.32 | −0.87 | 0.93 | 1.37 | 4 |
| 144 | −1.12 | 0.36 | −1.03 | 1.09 | 1.56 | 4 |
| 168 | −1.19 | 0.36 | −1.23 | 1.28 | 1.75 | 4 |
| 192 | −1.25 | 0.38 | −1.56 | 1.61 | 2.03 | 4 |
| 216 | −1.50 | 0.39 | −1.47 | 1.52 | 2.14 | 4 |
| 240 | −1.65 | 0.40 | −1.60 | 1.65 | 2.33 | 3/4 |
| 264 | −1.79 | 0.44 | −1.88 | 1.93 | 2.63 | 3/4 |
| 288 | −1.81 | 0.43 | −2.09 | 2.13 | 2.80 | 3/4 |
| 312 | −1.84 | 0.46 | −2.39 | 2.43 | 3.05 | 3 |
| 336 | −1.84 | 0.47 | −2.51 | 2.55 | 3.15 | 3 |
| 360 | −2.01 | 0.48 | −2.57 | 2.61 | 3.30 | 3 |

NUANCE 830 EO NAE 3766

| | | | | | |
|---|---|---|---|---|---|
| DL | DA | DB | C | DE | G.Sc. |

SOLAR TEST

| | | | | | |
|---|---|---|---|---|---|
| Langley | | | | | |
| | 0 | 0 | 0 | 0 | 0 |
| 20000 | −0.42 | −0.03 | 0.32 | 0.32 | 0.53 |
| 40000 | −0.59 | −0.01 | 0.34 | 0.34 | 0.68 |
| 60000 | −0.58 | −0.04 | 0.19 | 0.19 | 0.61 |
| 105000 | −0.74 | −0.06 | 0.22 | 0.23 | 0.77 |

FSTS

| | | | | | | |
|---|---|---|---|---|---|---|
| Time (hs) | | | | | | |
| 0 | 0.00 | 0.00 | 0.00 | 0.00 | 0.00 | |
| 24 | −0.40 | 0.09 | 0.24 | 0.26 | 0.48 | 4/5 |
| 48 | −0.77 | 0.16 | 0.42 | 0.45 | 0.89 | 4/5 |
| 72 | −0.82 | 0.11 | 0.31 | 0.33 | 0.88 | 4/5 |
| 96 | −0.92 | 0.15 | 0.31 | 0.34 | 0.98 | 4/5 |
| 120 | −1.22 | 0.17 | 0.39 | 0.43 | 1.29 | 4 |
| 144 | −1.41 | 0.20 | 0.48 | 0.52 | 1.50 | 4 |
| 168 | −1.31 | 0.16 | 0.44 | 0.47 | 1.39 | 4 |
| 192 | −1.39 | 0.16 | 0.49 | 0.52 | 1.48 | 4 |
| 216 | −1.61 | 0.14 | 0.42 | 0.44 | 1.67 | 4 |
| 240 | −1.60 | 0.16 | 0.43 | 0.46 | 1.66 | 4 |
| 264 | −1.63 | 0.11 | 0.35 | 0.37 | 1.67 | 4 |
| 288 | −1.61 | 0.15 | 0.33 | 0.36 | 1.65 | 4 |
| 312 | −1.62 | 0.11 | 0.37 | 0.39 | 1.67 | 4 |
| 336 | −1.50 | 0.01 | 0.17 | 0.17 | 1.51 | 4 |

Nuance 149B EO NAE 4601

| | | | | | |
|---|---|---|---|---|---|
| DL | DA | DB | C | DE | G.Sc. |

SOLAR TEST

| | | | | | |
|---|---|---|---|---|---|
| Langley | | | | | |
| 0 | 0 | 0 | 0 | 0 | 0 |
| 20000 | 0.07 | 0.01 | 0.32 | 0.32 | 0.33 |
| 40000 | −0.22 | 0.10 | 0.25 | 0.27 | 0.35 |
| 60000 | −0.36 | 0.15 | 0.18 | 0.23 | 0.43 |
| 105000 | −0.25 | 0.18 | 0.07 | 0.19 | 0.32 |

FSTS

| | | | | | | |
|---|---|---|---|---|---|---|
| Time (hs) | | | | | | |
| 0 | 0.00 | 0.00 | 0.00 | 0.00 | 0.00 | |
| 24 | −0.54 | 0.13 | 0.51 | 0.53 | 0.75 | 4/5 |
| 48 | −0.73 | 0.15 | 0.58 | 0.60 | 0.94 | 4/5 |
| 72 | −0.74 | 0.15 | 0.50 | 0.52 | 0.91 | 4/5 |
| 96 | −0.82 | 0.18 | 0.43 | 0.47 | 0.94 | 4/5 |
| 120 | −1.05 | 0.20 | 0.48 | 0.52 | 1.17 | 4/5 |
| 144 | −1.27 | 0.24 | 0.56 | 0.61 | 1.41 | 4 |
| 168 | −1.13 | 0.22 | 0.61 | 0.65 | 1.30 | 4 |
| 192 | −1.09 | 0.24 | 0.58 | 0.63 | 1.26 | 4/5 |
| 216 | −1.38 | 0.22 | 0.64 | 0.68 | 1.54 | 4 |
| 240 | −1.57 | 0.21 | 0.47 | 0.51 | 1.65 | 4 |
| 264 | −1.75 | 0.28 | 0.47 | 0.55 | 1.83 | 4 |
| 288 | −1.80 | 0.23 | 0.50 | 0.55 | 1.88 | 4 |
| 312 | −1.80 | 0.25 | 0.53 | 0.59 | 1.89 | 4 |
| 336 | −1.91 | 0.37 | 0.50 | 0.62 | 2.01 | 4 |
| 360 | −1.94 | 0.32 | 0.45 | 0.55 | 2.02 | 4 |

Nuance 311N EO WGNYGB NAE 4819

| | | | | | |
|---|---|---|---|---|---|
| DL | DA | DB | C | DE | G.Sc. |

SOLAR TEST

| | | | | | |
|---|---|---|---|---|---|
| Langley | | | | | |
| | 0 | 0 | 0 | 0 | 0 |
| 20000 | −0.15 | 0.01 | 0.28 | 0.28 | 0.32 |
| 40000 | −0.32 | 0.14 | 0.24 | 0.28 | 0.42 |
| 60000 | −0.21 | 0.27 | 0.20 | 0.34 | 0.40 |
| 105000 | −0.34 | 0.51 | 0.36 | 0.62 | 0.71 |

FSTS

| | | | | | | |
|---|---|---|---|---|---|---|
| Time (hs) | | | | | | |
| 0 | 0.00 | 0.00 | 0.00 | 0.00 | 0.00 | |
| 24 | −0.52 | 0.08 | 0.47 | 0.48 | 0.71 | 4/5 |
| 48 | −0.60 | 0.08 | 0.50 | 0.51 | 0.79 | 4/5 |
| 72 | −0.73 | 0.10 | 0.42 | 0.43 | 0.85 | 4/5 |
| 96 | −0.64 | 0.12 | 0.47 | 0.49 | 0.80 | 4/5 |
| 120 | −0.80 | 0.17 | 0.50 | 0.53 | 0.96 | 4/5 |
| 144 | −1.21 | 0.18 | 0.57 | 0.60 | 1.35 | 4 |
| 168 | −1.09 | 0.18 | 0.73 | 0.75 | 1.32 | 4 |
| 192 | −1.05 | 0.17 | 0.82 | 0.84 | 1.34 | 4 |
| 216 | −1.25 | 0.22 | 0.72 | 0.75 | 1.46 | 4 |
| 240 | −1.27 | 0.25 | 0.62 | 0.67 | 1.44 | 4 |
| 264 | −1.45 | 0.37 | 0.65 | 0.75 | 1.63 | 4 |
| 288 | −1.65 | 0.40 | 0.65 | 0.76 | 1.82 | 4 |
| 312 | −1.95 | 0.43 | 0.70 | 0.82 | 2.12 | 3/4 |
| 336 | −1.65 | 0.43 | 0.77 | 0.88 | 1.87 | 4 |
| 360 | −1.78 | 0.46 | 0.75 | 0.88 | 1.99 | 4 |

Nuance 311N EO WGNYGB NAE 5074

| | | | | | |
|---|---|---|---|---|---|
| DL | DA | DB | C | DE | G.Sc. |

SOLAR TEST

| | | | | | |
|---|---|---|---|---|---|
| Langley | | | | | |
| | 0 | 0 | 0 | 0 | 0 |
| 20000 | 0.80 | −0.21 | 0.54 | 0.58 | 0.99 |
| 40000 | 1.16 | −0.18 | 0.48 | 0.51 | 1.27 |
| 60000 | 1.40 | −0.22 | 0.46 | 0.51 | 1.49 |
| 105000 | 1.82 | −0.10 | 0.22 | 0.24 | 1.84 |

FSTS

| | | | | | | |
|---|---|---|---|---|---|---|
| Time (hs) | | | | | | |
| 0 | 0.00 | 0.00 | 0.00 | 0.00 | 0.00 | |
| 24 | 0.29 | 0.13 | 0.40 | 0.42 | 0.51 | 4/5 |
| 48 | 0.45 | 0.05 | 0.62 | 0.62 | 0.77 | 4/5 |
| 72 | 0.59 | 0.00 | 0.50 | 0.50 | 0.77 | 4/5 |
| 96 | 0.74 | −0.06 | 0.52 | 0.52 | 0.91 | 4/5 |
| 120 | 0.64 | −0.05 | 0.62 | 0.62 | 0.89 | 4/5 |
| 144 | 0.54 | −0.04 | 0.71 | 0.71 | 0.89 | 4/5 |
| 168 | 0.75 | −0.10 | 0.77 | 0.78 | 1.08 | 4/5 |
| 192 | 0.90 | −0.14 | 0.74 | 0.75 | 1.17 | 4/5 |
| 216 | 0.82 | −0.17 | 0.80 | 0.82 | 1.16 | 4/5 |
| 240 | 0.92 | −0.19 | 0.74 | 0.76 | 1.20 | 4/5 |
| 264 | 1.15 | −0.10 | 0.93 | 0.94 | 1.48 | 4 |
| 288 | 0.95 | −0.15 | 0.70 | 0.72 | 1.19 | 4/5 |
| 312 | 0.92 | −0.24 | 0.77 | 0.81 | 1.22 | 4/5 |
| 336 | 1.04 | −0.24 | 0.63 | 0.67 | 1.24 | 4/5 |
| 360 | 1.15 | −0.24 | 0.68 | 0.72 | 1.36 | 4 |

Nuance 311N EO WGNYGB NAE 5076

| | | | | | |
|---|---|---|---|---|---|
| DL | DA | DB | C | DE | G.Sc. |

SOLAR TEST

| | | | | | |
|---|---|---|---|---|---|
| Langley | | | | | |
| 0 | 0 | 0 | 0 | 0 | 0 |
| 20000 | 0.10 | 0.09 | 0.01 | 0.09 | 0.13 |
| 40000 | 0.06 | 0.24 | −0.03 | 0.24 | 0.25 |
| 60000 | 0.16 | 0.34 | −0.01 | 0.34 | 0.38 |
| 105000 | 0.06 | 0.63 | 0.06 | 0.63 | 0.64 |

FSTS

| | | | | | | |
|---|---|---|---|---|---|---|
| Time (hs) | | | | | | |
| 0 | 0.00 | 0.00 | 0.00 | 0.00 | 0.00 | |
| 24 | −0.43 | 0.12 | 0.34 | 0.36 | 0.56 | 4/5 |
| 48 | −0.60 | 0.15 | 0.21 | 0.26 | 0.65 | 4/5 |
| 72 | −0.64 | 0.18 | 0.15 | 0.23 | 0.68 | 4/5 |
| 96 | −0.64 | 0.22 | 0.19 | 0.29 | 0.70 | 4/5 |
| 120 | −0.84 | 0.25 | 0.20 | 0.32 | 0.90 | 4/5 |
| 144 | −1.22 | 0.26 | 0.13 | 0.29 | 1.25 | 4 |
| 168 | −0.97 | 0.27 | 0.25 | 0.37 | 1.04 | 4/5 |
| 192 | −1.32 | 0.34 | 0.21 | 0.40 | 1.38 | 4 |
| 216 | −1.49 | 0.34 | 0.14 | 0.37 | 1.53 | 4 |
| 240 | −1.47 | 0.37 | 0.16 | 0.40 | 1.52 | 4 |
| 264 | −1.61 | 0.48 | 0.32 | 0.58 | 1.71 | 4 |
| 288 | −1.59 | 0.49 | 0.28 | 0.56 | 1.69 | 4 |
| 312 | −1.57 | 0.52 | 0.16 | 0.54 | 1.66 | 4 |
| 336 | −1.64 | 0.49 | 0.18 | 0.52 | 1.72 | 4 |
| 360 | −1.60 | 0.51 | 0.33 | 0.61 | 1.71 | 4 |

Nuance 314N EO NAE 5077

| | | | | | |
|---|---|---|---|---|---|
| DL | DA | DB | C | DE | G.Sc. |

SOLAR TEST

| | | | | | |
|---|---|---|---|---|---|
| Langley | | | | | |
| 0 | 0 | 0 | 0 | 0 | 0 |
| 20000 | −0.02 | 0.01 | 0.05 | 0.05 | 0.05 |
| 40000 | −0.07 | −0.01 | −0.18 | 0.18 | 0.19 |
| 60000 | −0.11 | 0.05 | −0.13 | 0.14 | 0.18 |
| 105000 | −0.57 | 0.04 | −0.25 | 0.25 | 0.62 |

FSTS

| | | | | | | |
|---|---|---|---|---|---|---|
| Time (hs) | | | | | | |
| 0 | 0.00 | 0.00 | 0.00 | 0.00 | 0.00 | |
| 24 | −0.48 | 0.08 | −0.07 | 0.11 | 0.49 | 4/5 |
| 48 | −0.73 | 0.13 | 0.06 | 0.14 | 0.74 | 4/5 |
| 72 | −0.78 | 0.12 | −0.05 | 0.13 | 0.79 | 4/5 |
| 96 | −0.71 | 0.08 | −0.14 | 0.16 | 0.73 | 4/5 |
| 120 | −1.06 | 0.12 | −0.15 | 0.19 | 1.08 | 4/5 |
| 144 | −1.26 | 0.20 | −0.06 | 0.21 | 1.28 | 4 |
| 168 | −1.20 | 0.20 | −0.04 | 0.20 | 1.22 | 4/5 |
| 192 | −1.22 | 0.18 | −0.24 | 0.30 | 1.26 | 4/5 |
| 216 | −1.72 | 0.24 | −0.20 | 0.31 | 1.75 | 4/5 |
| 240 | −1.62 | 0.24 | 0.00 | 0.24 | 1.64 | 4 |
| 264 | −1.83 | 0.24 | −0.06 | 0.25 | 1.85 | 4 |
| 288 | −1.95 | 0.25 | −0.10 | 0.27 | 1.97 | 4 |
| 312 | −2.03 | 0.26 | −0.05 | 0.26 | 2.05 | 4 |
| 336 | −1.86 | 0.23 | −0.13 | 0.26 | 1.88 | 4 |
| 360 | −2.05 | 0.19 | −0.07 | 0.20 | 2.06 | 4 |

Nuance 311N EO WGNYGB NAE 5226

| | | | | | |
|---|---|---|---|---|---|
| DL | DA | DB | C | DE | G.Sc. |

SOLAR TEST

| | | | | | | |
|---|---|---|---|---|---|---|
| Langley | | | | | | |
| | 0 | 0 | 0 | 0 | 0 | 0 |
| 20000 | 0.27 | 0.05 | 0.12 | 0.13 | 0.30 | |
| 40000 | 0.07 | 0.23 | −0.06 | 0.24 | 0.25 | |
| 60000 | 0.17 | 0.40 | 0.07 | 0.41 | 0.44 | |
| 105000 | 0.36 | 0.77 | 0.34 | 0.84 | 0.92 | |

FSTS

| | | | | | | |
|---|---|---|---|---|---|---|
| Time (hs) | | | | | | |
| 0 | 0.00 | 0.00 | 0.00 | 0.00 | 0.00 | |
| 24 | −0.28 | 0.10 | 0.33 | 0.34 | 0.44 | 4/5 |
| 48 | −0.33 | 0.10 | 0.36 | 0.37 | 0.50 | 4/5 |
| 72 | −0.30 | 0.14 | 0.22 | 0.26 | 0.40 | 4/5 |
| 96 | −0.31 | 0.17 | 0.17 | 0.24 | 0.39 | 5 |
| 120 | −0.42 | 0.20 | 0.32 | 0.38 | 0.56 | 4/5 |
| 144 | −0.79 | 0.25 | 0.45 | 0.51 | 0.94 | 4/5 |
| 168 | −0.62 | 0.28 | 0.50 | 0.57 | 0.84 | 4/5 |
| 192 | −0.93 | 0.36 | 0.67 | 0.76 | 1.20 | 4 |
| 216 | −1.00 | 0.42 | 0.53 | 0.68 | 1.21 | 4 |
| 240 | −1.08 | 0.49 | 0.73 | 0.88 | 1.39 | 4 |
| 264 | −1.24 | 0.51 | 0.71 | 0.87 | 1.52 | 4 |
| 288 | −1.34 | 0.57 | 0.61 | 0.83 | 1.58 | 4 |
| 312 | −1.45 | 0.59 | 0.65 | 0.88 | 1.70 | 4 |
| 336 | −1.69 | 0.62 | 0.64 | 0.89 | 1.91 | 4 |
| 360 | −1.58 | 0.67 | 0.70 | 0.97 | 1.85 | 4 |

Nuance 830K Fons. NAE 5479

| | | | | | |
|---|---|---|---|---|---|
| DL | DA | DB | C | DE | G.Sc. |

SOLAR TEST

| | | | | | |
|---|---|---|---|---|---|
| Langley | | | | | |
| 0 | 0 | 0 | 0 | 0 | 0 |
| 20000 | 0.24 | −0.21 | 0.34 | 0.40 | 0.47 |
| 40000 | 0.44 | −0.54 | 0.68 | 0.87 | 0.97 |
| 60000 | 0.81 | −0.89 | 0.94 | 1.29 | 1.53 |
| 105000 | 1.53 | −1.58 | 1.84 | 2.43 | 2.87 |

FSTS

| | | | | | | |
|---|---|---|---|---|---|---|
| Time (hs) | | | | | | |
| 0 | 0.00 | 0.00 | 0.00 | 0.00 | 0.00 | |
| 24 | −0.31 | −0.14 | 0.28 | 0.31 | 0.44 | 4/5 |
| 48 | −0.32 | −0.43 | 0.65 | 0.78 | 0.84 | 4/5 |
| 72 | −0.17 | −0.75 | 0.77 | 1.07 | 1.09 | 4/5 |
| 96 | 0.06 | −1.05 | 0.90 | 1.38 | 1.38 | 4 |
| 120 | 0.10 | −1.25 | 1.02 | 1.61 | 1.62 | 4 |
| 144 | 0.09 | −1.54 | 1.43 | 2.10 | 2.10 | 4 |
| 168 | 0.36 | −1.95 | 1.61 | 2.53 | 2.55 | 3/4 |
| 192 | 0.53 | −2.38 | 1.86 | 3.02 | 3.07 | 3 |
| 216 | 0.76 | −2.99 | 2.26 | 3.75 | 3.82 | 3 |
| 240 | 0.89 | −3.21 | 2.24 | 3.91 | 4.01 | 3 |
| 264 | 0.98 | −3.81 | 2.65 | 4.64 | 4.74 | 2/3 |
| 288 | 1.05 | −3.82 | 2.58 | 4.61 | 4.73 | 2/3 |
| 312 | 1.11 | −3.89 | 2.74 | 4.76 | 4.89 | 2/3 |
| 336 | 1.31 | −4.17 | 2.83 | 5.04 | 5.21 | 2/3 |
| 360 | 1.25 | −4.15 | 2.98 | 5.11 | 5.26 | 2/3 |

Nuance 830K Fons. NAE 6137

| | | | | | |
|---|---|---|---|---|---|
| DL | DA | DB | C | DE | G.Sc. |

SOLAR TEST

| | | | | | |
|---|---|---|---|---|---|
| Langley | | | | | |
| 0 | 0 | 0 | 0 | 0 | 0 |
| 20000 | 0.01 | −0.14 | 0.18 | 0.23 | 0.23 |
| 40000 | 0.11 | −0.31 | 0.33 | 0.45 | 0.47 |
| 60000 | 0.26 | −0.57 | 0.58 | 0.81 | 0.85 |
| 105000 | 0.79 | −1.06 | 1.23 | 1.62 | 1.81 |

FSTS

| | | | | | | |
|---|---|---|---|---|---|---|
| Time (hs) | | | | | | |
| 0 | 0.00 | 0.00 | 0.00 | 0.00 | 0.00 | |
| 24 | −0.36 | −0.04 | 0.28 | 0.28 | 0.46 | 4/5 |
| 48 | −0.33 | −0.20 | 0.37 | 0.42 | 0.53 | 4/5 |
| 72 | −0.28 | −0.38 | 0.40 | 0.55 | 0.62 | 4/5 |
| 96 | −0.25 | −0.40 | 0.48 | 0.62 | 0.67 | 4/5 |
| 120 | −0.10 | −0.61 | 0.50 | 0.79 | 0.80 | 4/5 |
| 144 | 0.03 | −0.73 | 0.56 | 0.92 | 0.92 | 4/5 |
| 168 | −0.11 | −0.96 | 0.78 | 1.24 | 1.24 | 4/5 |
| 192 | 0.08 | −1.35 | 1.03 | 1.70 | 1.70 | 4 |
| 216 | 0.09 | −1.66 | 1.27 | 2.09 | 2.09 | 4 |
| 240 | 0.25 | −1.80 | 1.24 | 2.19 | 2.20 | 3/4 |
| 264 | 0.29 | −2.17 | 1.42 | 2.59 | 2.61 | 3/4 |
| 288 | 0.35 | −2.27 | 1.55 | 2.75 | 2.77 | 3/4 |
| 312 | 0.42 | −2.33 | 1.66 | 2.86 | 2.89 | 3/4 |
| 336 | 0.24 | −2.43 | 1.66 | 2.94 | 2.95 | 3/4 |
| 360 | 0.15 | −2.42 | 1.79 | 3.01 | 3.01 | 3/4 |

Nuance 830K Fons. 040207 VAR1 NAE 6138

| | | | | | |
|---|---|---|---|---|---|
| DL | DA | DB | C | DE | G.Sc. |

SOLAR TEST

| | | | | | |
|---|---|---|---|---|---|
| Langley | | | | | |
| | 0 | 0 | 0 | 0 | 0 |
| 20000 | −0.08 | −0.16 | 0.20 | 0.26 | 0.27 |
| 40000 | 0.02 | −0.34 | 0.40 | 0.52 | 0.53 |
| 60000 | 0.20 | −0.60 | 0.70 | 0.92 | 0.94 |
| 105000 | 0.68 | −0.96 | 1.36 | 1.66 | 1.80 |

FSTS

| | | | | | | |
|---|---|---|---|---|---|---|
| Time (hs) | | | | | | |
| 0 | 0.00 | 0.00 | 0.00 | 0.00 | 0.00 | |
| 24 | −0.36 | −0.08 | 0.26 | 0.27 | 0.45 | 4/5 |
| 48 | −0.39 | −0.14 | 0.30 | 0.33 | 0.51 | 4/5 |
| 72 | −0.33 | −0.27 | 0.36 | 0.45 | 0.56 | 4/5 |
| 96 | −0.25 | −0.40 | 0.48 | 0.62 | 0.67 | 4/5 |
| 120 | −0.15 | −0.46 | 0.52 | 0.69 | 0.71 | 4/5 |
| 144 | −0.17 | −0.57 | 0.50 | 0.76 | 0.78 | 4/5 |
| 168 | −0.15 | −0.82 | 0.68 | 1.07 | 1.08 | 4/5 |
| 192 | −0.14 | −1.09 | 0.82 | 1.36 | 1.37 | 4/5 |
| 216 | −0.14 | −1.36 | 1.15 | 1.78 | 1.79 | 4 |
| 240 | 0.14 | −1.59 | 1.20 | 1.99 | 2.00 | 4 |
| 264 | 0.18 | −1.79 | 1.30 | 2.21 | 2.22 | 3/4 |
| 288 | 0.19 | −1.89 | 1.40 | 2.35 | 2.36 | 3/4 |
| 312 | 0.22 | −2.09 | 1.47 | 2.56 | 2.56 | 3/4 |
| 336 | 0.28 | −2.30 | 1.63 | 2.82 | 2.83 | 3/4 |
| 360 | 0.25 | −2.35 | 1.76 | 2.94 | 2.95 | 3/4 |

Nuance 830K Fons. NAE 6139

| | | | | | |
|---|---|---|---|---|---|
| DL | DA | DB | C | DE | G.Sc. |

SOLAR TEST

| | | | | | |
|---|---|---|---|---|---|
| Langley | | | | | |
| | 0 | 0 | 0 | 0 | 0 |
| 20000 | 0.21 | −0.21 | −0.02 | 0.21 | 0.30 |
| 40000 | 0.09 | −0.31 | 0.23 | 0.39 | 0.40 |
| 60000 | 0.25 | −0.53 | 0.37 | 0.65 | 0.69 |
| 105000 | 0.70 | −1.00 | 0.83 | 1.30 | 1.48 |

FSTS

| | | | | | | |
|---|---|---|---|---|---|---|
| Time (hs) | | | | | | |
| 0 | 0.00 | 0.00 | 0.00 | 0.00 | 0.00 | |
| 24 | −0.22 | −0.12 | 0.14 | 0.18 | 0.29 | 5 |
| 48 | −0.31 | −0.21 | 0.20 | 0.29 | 0.42 | 4/5 |
| 72 | −0.25 | −0.29 | 0.22 | 0.36 | 0.44 | 4/5 |
| 96 | 0.25 | −0.54 | 0.24 | 0.59 | 0.64 | 4/5 |
| 120 | 0.20 | −0.65 | 0.29 | 0.71 | 0.74 | 4/5 |
| 144 | 0.12 | −0.79 | 0.34 | 0.86 | 0.87 | 4/5 |
| 168 | −0.01 | −1.00 | 0.68 | 1.21 | 1.21 | 4/5 |
| 192 | 0.05 | −1.33 | 0.66 | 1.48 | 1.49 | 4 |
| 216 | 0.01 | −1.49 | 0.86 | 1.72 | 1.72 | 4 |
| 240 | 0.38 | −1.76 | 0.94 | 2.00 | 2.03 | 4 |
| 264 | 0.35 | −1.95 | 1.02 | 2.20 | 2.23 | 3/4 |
| 288 | 0.32 | −2.00 | 1.12 | 2.29 | 2.31 | 3/4 |
| 312 | 0.23 | −2.20 | 1.20 | 2.51 | 2.52 | 3/4 |
| 336 | 0.44 | −2.28 | 1.16 | 2.56 | 2.60 | 3/4 |
| 360 | 0.49 | −2.38 | 1.25 | 2.69 | 2.73 | 3/4 |

Nuance 830K Fons. NAE 6142

| | | | | | |
|---|---|---|---|---|---|
| DL | DA | DB | C | DE | G.Sc. |

SOLAR TEST

| | | | | | |
|---|---|---|---|---|---|
| Langley | | | | | |
| | 0 | 0 | 0 | 0 | 0 |
| 20000 | 0.15 | −0.20 | 0.09 | 0.22 | 0.27 |
| 40000 | 0.27 | −0.33 | 0.28 | 0.43 | 0.51 |
| 60000 | 0.45 | −0.53 | 0.47 | 0.71 | 0.84 |
| 105000 | 1.03 | −0.82 | 1.04 | 1.32 | 1.68 |

FSTS

| | | | | | | |
|---|---|---|---|---|---|---|
| Time (hs) | | | | | | |
| 0 | 0.00 | 0.00 | 0.00 | 0.00 | 0.00 | |
| 24 | −0.15 | −0.13 | 0.11 | 0.17 | 0.23 | 5 |
| 48 | −0.27 | −0.15 | 0.20 | 0.25 | 0.37 | 5 |
| 72 | −0.19 | −0.31 | 0.22 | 0.38 | 0.42 | 4/5 |
| 96 | 0.07 | −0.40 | 0.25 | 0.47 | 0.48 | 4/5 |
| 120 | 0.10 | −0.55 | 0.35 | 0.65 | 0.66 | 4/5 |
| 144 | 0.05 | −0.65 | 0.49 | 0.81 | 0.82 | 4/5 |
| 168 | −0.05 | −0.89 | 0.57 | 1.06 | 1.06 | 4/5 |
| 192 | −0.09 | −1.24 | 0.75 | 1.45 | 1.45 | 4 |
| 216 | −0.18 | −1.57 | 1.06 | 1.89 | 1.90 | 4 |
| 240 | 0.32 | −1.70 | 0.97 | 1.96 | 1.98 | 4 |
| 264 | 0.22 | −1.81 | 1.14 | 2.14 | 2.15 | 4 |
| 288 | 0.15 | −2.05 | 1.19 | 2.37 | 2.38 | 3/4 |
| 312 | 0.03 | −2.21 | 1.25 | 2.54 | 2.54 | 3/4 |
| 336 | 0.07 | −2.27 | 1.29 | 2.61 | 2.61 | 3/4 |
| 360 | 0.19 | −2.27 | 1.33 | 2.63 | 2.64 | 3/4 |

Nuance 830K Fons. NAE 6213

| | | | | | |
|---|---|---|---|---|---|
| DL | DA | DB | C | DE | G.Sc. |

SOLAR TEST

| | | | | | |
|---|---|---|---|---|---|
| Langley | | | | | |
| | 0 | 0 | 0 | 0 | 0 |
| 20000 | 0.11 | −0.18 | 0.07 | 0.19 | 0.22 |
| 40000 | 0.16 | −0.36 | 0.26 | 0.44 | 0.47 |
| 60000 | 0.40 | −0.63 | 0.35 | 0.72 | 0.82 |
| 105000 | 0.83 | −1.07 | 0.76 | 1.31 | 1.55 |

FSTS

| | | | | | | |
|---|---|---|---|---|---|---|
| Time (hs) | | | | | | |
| 0 | 0.00 | 0.00 | 0.00 | 0.00 | 0.00 | |
| 24 | −0.40 | −0.08 | 0.14 | 0.16 | 0.43 | 4/5 |
| 48 | −0.38 | −0.09 | 0.23 | 0.25 | 0.45 | 4/5 |
| 72 | −0.29 | −0.24 | 0.26 | 0.35 | 0.46 | 4/5 |
| 96 | −0.21 | −0.36 | 0.30 | 0.47 | 0.51 | 4/5 |
| 120 | 0.02 | −0.57 | 0.52 | 0.77 | 0.77 | 4/5 |
| 144 | −0.02 | −0.88 | 0.64 | 1.09 | 1.09 | 4/5 |
| 168 | −0.14 | −0.97 | 0.73 | 1.21 | 1.22 | 4/5 |
| 192 | −0.12 | −1.38 | 0.93 | 1.66 | 1.67 | 4 |
| 216 | −0.23 | −1.63 | 1.11 | 1.97 | 1.99 | 4 |
| 240 | 0.05 | −1.71 | 1.05 | 2.01 | 2.01 | 4 |
| 264 | 0.13 | −1.96 | 1.19 | 2.29 | 2.30 | 3/4 |
| 288 | 0.21 | −2.05 | 1.29 | 2.42 | 2.43 | 3/4 |
| 312 | 0.18 | −2.16 | 1.36 | 2.55 | 2.56 | 3/4 |
| 336 | 0.15 | −2.36 | 1.42 | 2.75 | 2.76 | 3/4 |
| 360 | 0.21 | −2.41 | 1.53 | 2.85 | 2.86 | 3/4 |

By analysis of the color variations obtained in the solar test and the FSTS test it can be noticed that the same are very similar as to the value and sign. Also it may be appreciated that the samples having a stable and good tone show these conditions in both equipments. The leather tested samples were sent to the firm GMC, for visual approval or rejection of the same and the observers coincided in the evaluation of the total samples. Finally, the inventive method allows to emulate or simulate the changes that are produced in the samples when subject to the Solar Test.

The FSTS has many advantages such as low costs, rapid results and working capacity while being very simple for operating. It also provides good repeatable results and, thank to the speed that the changes or alterations are obtained, the development of colors and new colorations is expedited thus permitting a better control on the production what is very important to guarantee a constant quality in the products. It is also possible to control the pigments to better prevent any kind of troubles and for better selection of the pigments for each particular color.

The FST requires of few controls and low maintenance as long as the only control is on the lamps, reflectors, to which purpose the spectrometer is employed to control the spectral curve and the optometer is employed to control the radiation intensity of the lamps to determine the life expectancy of the lamps.

In order to guarantee a perfect correlation to the Solar Test, when the test is carried out with any sample, two additional samples should be placed, one is the Nuance 830k LG terminated in EONA, which has been employed in the first test with good results for two different leathers, as well as three leathers of the simple 830K LG IDN 060125 PA which is being tested in the firm GMC, which is being employed as a witness simple passing through the Solar Test. The other sample employed as a witness sample (that failed) is the WO 4505 T from another leather. By means of these tests as well as all the above mentioned controls, the reliability of the inventive FSTS is guaranteed.

Parameters of the Inventive Apparatus

INTENSIDADES EN FST (w/m2)
RIGHT REFLECTOR

| Distance | UVB | UVA | UVB | UVA | Visible | IFC. | Total | Total |
|---|---|---|---|---|---|---|---|---|
| (cm) | 310 | 340 | 280/315 | 315/400 | 400/800 | 800/1000 | 280/1000 | (j/seg · m2) |
| 9 | 4.16 | 3.3 | 0.0052 | 56 | 969 | 193 | 1218 | 1218 |
| 10 | 3.82 | 3.1 | 0.0049 | 52 | 940 | 187 | 1179 | 1179 |
| 11 | 3.6 | 2.9 | 0.0046 | 49 | 887 | 175 | 1111 | 1111 |
| 12 | 3.4 | 2.8 | 0.0043 | 46 | 838 | 164 | 1048 | 1048 |
| 13 | 3.3 | 2.7 | 0.004 | 44 | 807 | 157 | 1008 | 1008 |
| 14 | 3.1 | 2.6 | 0.0038 | 41 | 768 | 150 | 959 | 959 |
| 15 | 3 | 2.4 | 0.0035 | 39 | 730 | 143 | 912 | 912 |

LEFT REFLECTOR

| Distance | UVB | UVA | UVB | UVA | Visible | IFC. | Total | Total |
|---|---|---|---|---|---|---|---|---|
| (cm) | 310 | 340 | 280/315 | 315/400 | 400/800 | 800/1000 | 280/1000 | (j/seg · m2) |
| 9 | 4.2 | 3.5 | 0.0054 | 61 | 1068 | 203 | 1332 | 1332 |
| 10 | 4.1 | 3.2 | 0.0052 | 57 | 1012 | 189 | 1258 | 1258 |
| 11 | 3.9 | 3 | 0.005 | 53 | 945 | 177 | 1175 | 1175 |
| 12 | 3.7 | 2.9 | 0.0047 | 50 | 909 | 161 | 1120 | 1120 |
| 13 | 3.5 | 2.8 | 0.0043 | 47 | 855 | 156 | 1058 | 1058 |
| 14 | 3.3 | 2.7 | 0.0041 | 45 | 803 | 147 | 995 | 995 |
| 15 | 3.2 | 2.5 | 0.0039 | 42 | 776 | 141 | 959 | 959 |

Working temperature: 100-115° C.
Distance: 9-15 cm.
Time: 360 Hs

While preferred embodiments of the present invention have been illustrated and described, it will be obvious to those skilled in the art that various changes and modifications may be made therein without departing from the scope of the invention as defined in the appended claims.

We claim:

1. Apparatus for testing the aging of materials under light exposure, the apparatus comprising:
a box defining a testing chamber;
a light source defining a light emission axis extending into said testing chamber;
a tray in the testing chamber for carrying at least one material sample, the tray having a sample supporting surface facing said light source and extending transversely to said light emission axis, and
a distance regulating mechanism connected to said tray to regulate the distance between said light source and the tray along said light emission axis.

2. The apparatus of claim 1, wherein said Light source comprises a light reflector and a lamp arranged into said reflector.

3. The apparatus of claim 1, wherein the light reflector is an outdoor reflector having a translucent tempered glass and aluminum carcass containing a reflecting screen and a 1000 Watts halogen lamp.

4. The apparatus of claim 3, wherein the lamp is mercury vapor discharge lamp.

5. The apparatus of claim 1, wherein the distance regulating mechanism comprises a scissors mechanism that extends and retracts along said light emission axis, with the scissors mechanism being mounted in at least one sliding track to positioning the scissors mechanism into a position relative to the light source.

6. The apparatus of claim 5, wherein the scissors mechanism is manually operated by a screw-and-knob assembly.

7. The apparatus of claim 1, further comprising a fan in the testing chamber and connected to a circuit including a thermostat to regulate the temperature into the testing chamber.

8. The apparatus of claim 1, further comprising a rule parallel to said light emission axis and wherein the tray includes a pointer running along and in front of the rule to read the distance between the tray and the light source.

9. The apparatus of claim 1, wherein the box includes a floor, side walls, an upper wall and an open front with at least one door to open and to close the box.

10. The apparatus of claim 9, wherein the light source is in the upper wall and said distance regulating mechanism is mounted in said floor.

11. The apparatus of claim 1, wherein the lamp has a UV radiation range of between about 280 nm and 400 nm.

12. The apparatus of claim 1, wherein the tray extends perpendicularly to said light emission axis.

13. A method to determine the aging of material under light exposure, in the apparatus of claim 1, wherein the method comprises the steps of:
providing at least one first sample of the material to be tested, with the first sample having being exposed to sun light for a period of at least 8 months, which exposure produced color deviations in the first sample;
providing a second sample of the material to be tested, with the second sample being not exposed to sun light;
placing the second sample in the tray into the apparatus;
varying the distance between the tray and the light source until reaching a position at which, for a determined period of time, the same color deviations produced by the sun light in the first sample are to be generated by the light source in the second sample,
turning the light source on,
fixing radiation conditions of the light source, temperature within the testing chamber and the distance between the tray and the light source to get an aging in the second sample that is equivalent to the aging produced in the first sample by the sun light, with the aging in the second sample being obtained in a period of time shorter that said period of at least 8 months, and
determining said period of time.

14. The method of claim 13, further comprising:
subjecting other samples of the material to the same radiation conditions and at the same distance between the tray and the light source, during said period of time, to get an aging in the other sample.
